(19) United States
(12) Patent Application Publication
(10) Pub. No.: US 2021/0372814 A1
(43) Pub. Date: Dec. 2, 2021

(54) MAP DATA COLLECTION DEVICE AND STORAGE MEDIUM STORING COMPUTER PROGRAM FOR MAP DATA COLLECTION

(71) Applicant: TOYOTA JIDOSHA KABUSHIKI KAISHA, Toyota-shi (JP)

(72) Inventor: Ryo IGARASHI, Chofu-shi (JP)

(21) Appl. No.: 17/327,875

(22) Filed: May 24, 2021

(30) Foreign Application Priority Data
May 29, 2020 (JP) 2020-094450

(51) Int. Cl. G01C 21/00; G01C 21/34; G01C 21/36

(52) U.S. Cl. CPC G01C 21/3822; G01C 21/367; G01C 21/3867; G01C 21/3461

(57) ABSTRACT

A map data collection device collects information for locations and attributes of road features contained in map data used for automatic operation control of a moving object, the map data collection device has a memory unit that stores map data containing information for the locations and attributes of one or more first road features, an input device that inputs information for the location and attributes of a second road feature detected using a sensor and a processor configured to refer to the map data stored in the memory unit, to select one first road feature present at the nearest location to the location of the second road feature, and to assess whether map data should be updated based on the attribute information for the first road feature, the attribute information for the second road feature and the distance between the first road feature and the second road feature.

### FIELD

The present invention relates to a map data collection device, and to a storage medium storing a computer program for map data collection.

### BACKGROUND

High-precision road map data that is to be referred to for automatic control of a vehicle by a vehicle self-driving system must accurately represent its road-associated information. Map data contains positional information for roads and for road features including lane marking lines, signs and structures around the roads.

Road features such as lane marking lines, signs and structures often vary or are relocated. It is therefore preferred for map data to have the information for such road features in a constantly updated state.

It has been proposed to update map data by having information for road features detected during vehicle travel sent to a server that manages the map data, and having the server compare the information for the road features that has been sent from the vehicle with information for the road features that has already been registered in the map data (see Japanese Unexamined Patent Publication No. 2014-228526, for example).

### SUMMARY

Since map data contains information relating to a large number of road features, it is preferable to lower the processing volume required for assessment of whether road feature information should be updated.

It is therefore an object of the present invention to provide a map data collection device that is able to assess the need for map data updating with low processing volume.

According to one embodiment of the invention there is provided a map data collection device. The map data collection device collects information for locations and attributes of road features contained in map data used for automatic operation control of a moving object, the map data collection device has a storage device that stores map data containing information for the locations and attributes of one or more first road features, an input device that inputs information for the location and attributes of a second road feature detected using a sensor installed in the moving object, and a processor configured to refer to the map data stored in the memory unit, to select one first road feature present at the nearest location to the location of the second road feature, and to assess the need for map data updating based on the attribute information for the first road feature, the attribute information for the second road feature and the distance between the first road feature and the second road feature.

In the map data collection device, the processor is preferably configured to assess that map data should be updated when the distance between the selected first road feature and the second road feature is below a predetermined threshold and the attribute information for the selected first road feature differs from the attribute information for the second road feature.

The processor in the map data collection device is also preferably configured to assess that map data should be updated when the distance between the selected first road feature and the second road feature is above a predetermined threshold and the attribute information for the selected first road feature is the same as the attribute information for the second road feature.

The processor in the map data collection device is also preferably configured to assess that map data should be updated when the distance between the selected first road feature and the second road feature is above a predetermined threshold and the attribute information for the selected first road feature differs from the attribute information for the second road feature.

In the map data collection device, the processor is preferably configured to assess that map data should not be updated when the distance between the selected first road feature and the second road feature is below a predetermined threshold and the attribute information for the selected first road feature is the same as the attribute information for the second road feature.

The processor in the map data collection device is also preferably configured to update the map data stored in the memory device based on the information for the location and attributes of a second road feature, when it has been assessed that an update should be made.

Preferably, the processor in the map data collection device is configured to count the number of assessments made that the map data should be updated for the selected first road feature, each time the processor assesses that map data should be updated, and the processor is configured to update the map data based on the information for the locations and attributes of a predetermined number of second road features used for assessment of the one first road feature, when the number of assessments that the map data should be updated has reached the predetermined number for the selected first road feature.

Preferably, the memory device in the map data collection device stores map data containing information for the locations and attributes of one or more first road features associated with each of a plurality of road zones, and the processor is configured to select, for each second road feature located in a single road zone that has been input through the input device, one first road feature present at the nearest location to the location of the second road feature from among the first road features associated with the road zone in the map data, to assess whether the map data should be updated based on the attribute information for the selected first road feature, the attribute information for the second road feature and the distance between the selected first road feature and the second road feature, and to make the assessment that any second road features that were not assessed are new road features.

According to another embodiment there is provided a computer-readable non-transitory storage medium which stores a computer program for map data collection. The computer program for map data collection is a computer program for collecting information for locations and attributes of road features contained in map data used for automatic operation control of a moving object. The computer program causes a processor to input information for the location and attributes of a second road feature detected using a sensor installed in the moving object via an input device, to refer to map data that is stored in a memory device and contains information for the locations and attributes of one or more first road features, to select one first road feature present at the nearest location to the location of the second road feature, and to assess whether map data should be updated based on the attribute information for the first road feature, the attribute information for the second road feature and the distance between the first road feature and the second road feature.

The object and advantages of the invention will be realized and attained by means of the elements and combinations particularly pointed out in the claims. It is to be understood that both the foregoing general description and the following detailed description are exemplary and explanatory and are not restrictive of the invention, as claimed

### BRIEF DESCRIPTION OF DRAWINGS

FIG. 1 is a general schematic drawing of a map data collecting system in which a map data collection device is mounted.

FIG. 2 is a general schematic drawing of a vehicle.

FIG. 3 is a hardware configuration diagram of a server.

FIG. 4 is an operation flow chart for a vehicle during map data collection processing.

FIG. 5 is an operation flow chart for a server during map data collection processing.

FIG. 6 is an operation flow chart for the assessment unit in a processor of a server.

FIG. 7 is an operation flow chart for the updating unit in a processor of a server.

### DESCRIPTION OF EMBODIMENTS

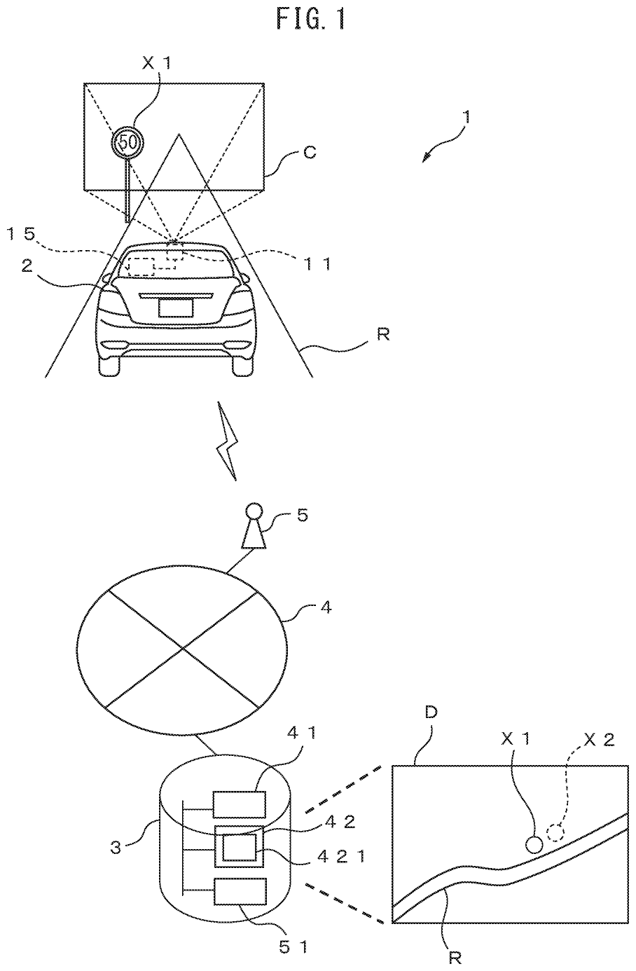

FIG. 1 is a general schematic drawing of a map data collecting system in which a map data collection device is mounted. The map data collecting system 1 disclosed herein will now be described in overview with reference to FIG. 1.

For this embodiment, the map data collecting system 1 comprises a map data acquiring device 15 mounted in at least one vehicle 2, and a server 3. The map data acquiring device 15 is connected with a server 3 via a base station 5 and a communication network 4 by accessing a wireless base station 5 that is connected through the communication network 4 and gateway (not shown) to which the server 3 is connected. Although only one vehicle 2 is depicted in FIG. 1, the map data collecting system 1 may have more than one vehicle 2. Likewise, more than one base station 5 may be connected to the communication network 4.

When the vehicle 2 is traveling on a road R, the map data acquiring device 15 uses a camera 11, as an example of a sensor installed in the vehicle 2, to acquire a camera image C in which the surrounding environment of the vehicle is represented. In the example shown in FIG. 1, the map data acquiring device 15 acquires a camera image C containing a road sign X1 indicating that the speed limit is 50 km/h.

The map data acquiring device 15 detects information for the location and attributes of the road feature X1 represented in the camera image C. The location of the road feature is represented by the world coordinate system, with a predetermined reference location in real space as the origin. The attribute information of road features indicates the types of road markings such as lane marking lines, stopping lines and speed displays, or structures such as speed displays or other road signs, or traffic lights. The map data acquiring device 15 sends the information for the location and attributes of the road feature that has been detected (hereunder also referred to as “detected road feature”) X1 to the server 3 via the base station 5 and communication network 4.

The server 3 includes a communication I/F 41 whereby the information for the location and attributes of the detected road feature X1 from the map data acquiring device 15 is input, a storage device 42 that stores the map data 421, and an assessment unit 51 that assesses whether the map should be updated.

The assessment unit 51 refers to the map data 421 that contains information for the locations and attributes of one or more registered road features, and selects one road feature registered in the map data 421 (hereunder, “registered road feature”) X2, that is present at the nearest location to the location of the detected road feature X1.

The assessment unit 51 assesses whether the map data 421 should be updated, based on the attribute information for the selected registered road feature X2, the attribute information for the detected road feature X1, and the distance between the selected registered road feature X2 and the detected road feature X1. The map D in FIG. 1 displays one section of the map data 421, with the detected road feature X1 and registered road feature X2 situated along the road R based on positional information.

Incidentally, while more than one vehicle 2 may be included in the map data collecting system 1, since each vehicle 2 has the same construction and conducts the same processing for map data collection processing, the following explanation will assume only a single vehicle 2.

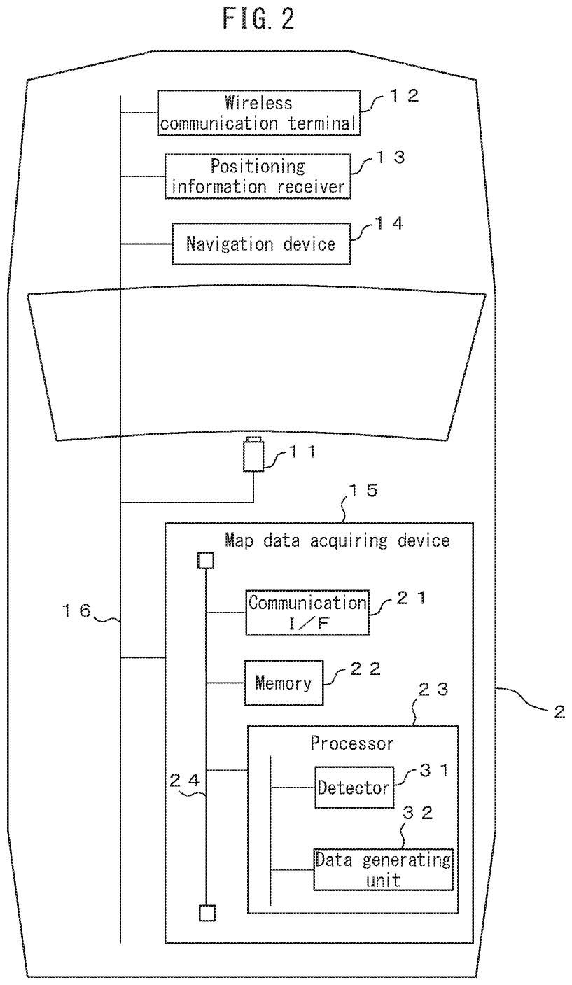

FIG. 2 is a general schematic drawing of the vehicle 2. The vehicle 2 comprises a camera 11 that photographs the environment in front of the vehicle 2, a wireless communication terminal 12, a positioning information receiver 13, a navigation device 14, and a map data acquiring device 15. The vehicle 2 may also have a LiDAR sensor, as a distance sensor (not shown) for measurement of the distance of the vehicle 2 to surrounding objects.

The camera 11, wireless communication terminal 12, positioning information receiver 13, navigation device 14 and map data acquiring device 15 are connected in a communicable manner through an in-vehicle network 16 that conforms to controller area network standards.

The camera 11 is mounted inside the compartment of the vehicle 2 and directed toward the front of the vehicle 2. The camera 11 acquires a camera image C in which the environment of a predetermined region that is ahead of the vehicle 2 is shown, at a predetermined cycle. The camera image C can show road features such as road surface lane marking lines that are within the predetermined region ahead of the vehicle 2. The image produced by the camera 11 may be a color image or a gray image. The camera 11 is an example of a sensor installed in the vehicle 2, and it has a 2D detector composed of an array of photoelectric conversion elements with visible light sensitivity, such as a CCD or C-MOS, and an imaging optical system that forms an image of the photographed region on the 2D detector.

The wireless communication terminal 12 is an example of a communication unit, being a device that carries out wireless communication processing conforming to a predetermined wireless communication standard, and for example, it accesses the base station 5 to connect with the server 3 through the base station 5 and communication network 4.

The positioning information receiver 13 outputs positioning information that represents the current location of the vehicle 2. The positioning information receiver 13 may be a GPS receiver, for example. The positioning information receiver 13 outputs positioning information and the positioning information acquisition time at which the positioning information has been acquired, to the navigation device 14 and map data acquiring device 15, each time positioning information is acquired at a predetermined receiving cycle.

The navigation device 14 produces a traveling route from the current location of the vehicle 2 to the destination, based on navigating map data, the destination of the vehicle 2 and the current location of the vehicle 2. The navigation device 14 uses positioning information output by the positioning information receiver 13 as the current location of the vehicle 2. Every time a traveling route is produced, the navigation device 14 outputs the traveling route to the map data acquiring device 15 through the in-vehicle network 16.

The map data acquiring device 15 carries out detection processing in which information for locations and attributes of road features represented in the camera image C are detected, and data generation processing in which acquired data containing the information for locations and attributes of detected road features are generated and the acquired data are sent to the server 3. For this purpose, the map data acquiring device 15 comprises a communication interface 21, a memory 22 and a processor 23. The communication interface 21, memory 22 and processor 23 are connected via signal wires 24.

The communication interface (I/F) 21 is an example of an in-vehicle communication unit, and it has an interface circuit to connect the map data acquiring device 15 with the in-vehicle network 16. In other words, the communication interface 21 is connected with the camera 11, the wireless communication terminal 12, the positioning information receiver 13 and the navigation device 14 through the in-vehicle network 16. Each time information for locations and attributes of detected road features is transferred from the processor 23, the communication interface 21 sends the transferred information for locations and attributes of detected road features to the wireless communication terminal 12.

The memory 22 is an example of a memory unit, and it has a volatile semiconductor memory and a non-volatile semiconductor memory, for example. The memory 22 stores an application computer program and data to be used for information processing carried out by the processor 23 of the map data acquiring device 15, and a vehicle ID for identification of the vehicle 2. The vehicle ID can be used to identify each vehicle 2 when the server 3 communicates with more than one vehicle 2, for example.

The processor 23 comprises one or more CPUs (Central Processing Units) and their peripheral circuits. The processor 23 may also have other computing circuits such as a logical operation unit, numerical calculation unit or graphic processing unit. When the processor 23 has multiple CPUs, it may have a separate memory for each CPU. The processor 23 carries out detection processing and data generation processing.

The processor 23 has a detector 31 that detects information for locations and attributes of road features represented in the camera image C, and a data generating unit 32 that generates data containing the information for locations and attributes of detected road features and sends the acquired data to the server 3. Each of the units of the processor 23 are functional modules driven by a computer program operating on the processor 23, for example. Alternatively, each of the units of the processor 23 may be specialized computing circuits in the processor 23.

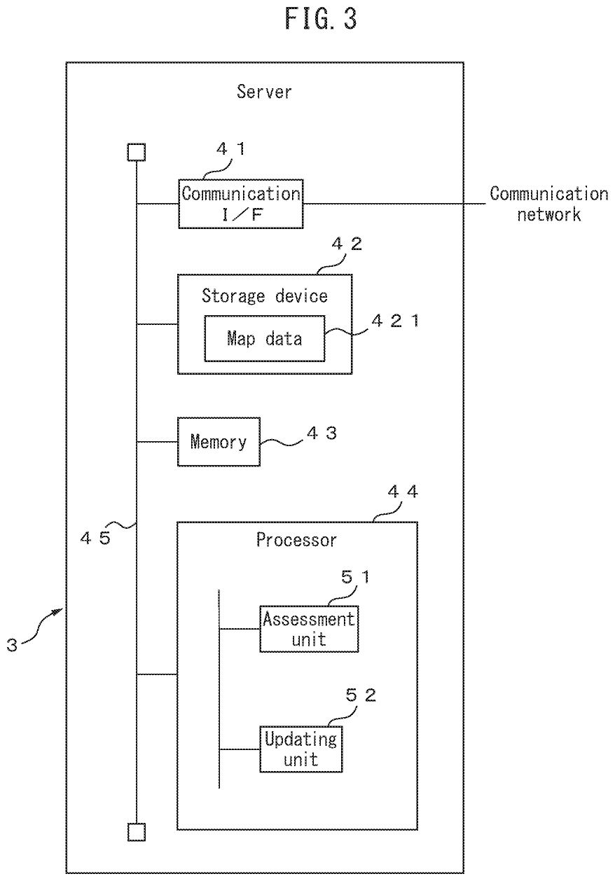

FIG. 3 is a hardware configuration diagram of a server 3. The server 3 comprises a communication interface 41, a storage device 42, a memory 43 and a processor 44. The communication interface 41, storage device 42, memory 43 and processor 44 are connected by signal wires 45. The server 3 may also comprise an input device such as a keyboard and mouse, and a display device such as a liquid crystal display.

The communication interface 41 is an example of an input device, and it has an interface circuit to connect the server 3 with the communication network 4. The communication interface 41 is configured in a communicable manner with the vehicle 2, communication network 4 and base station 5.

The storage device 42 is an example of a memory device/unit, and it comprises, for example, a hard disk device or optical recording medium, and a device for accessing it. The storage device 42 stores the map data 421 that has been updated by the processor 44. The storage device 42 may additionally store the vehicle ID of the vehicle 2. The storage device 42 may further store a computer program for carrying out server 3 processing related to map data collection processing, which is carried out in the processor 44.

The map data 421 contains information for locations and attributes of road features (such as lane marking lines, stop lines, speed indicators and other road markings, road signs or traffic lights) that define the traveling conditions for each road represented on the map. Each of the road features registered in the map data 421 (registered road features) is identified by road feature identification information (road feature ID) that identifies the road feature. The map data 421 has information for locations and attributes of registered road features, registered in association with their respective road feature IDs. The registered road features are registered in the map data 421 in association with the road zones in which the registered road features are located.

The memory 43 is another example of a memory device/unit, and it has a non-volatile semiconductor memory and a volatile semiconductor memory, for example. The memory 43 transiently stores data generated during execution of the server 3-related processing among the map data collection processing, and data acquired by communication with the vehicle 2, such as information for locations and attributes of detected road features received from the vehicle 2.

The processor 44 comprises one or more CPUs (Central Processing Units) and their peripheral circuits. The processor 44 may also have other computing circuits such as a logical operation unit or numerical calculation unit. The processor 44 carries out processing related to the server 3, among the map data collection processing.

The processor 44 has an assessment unit 51 that assesses whether the map data 421 should be updated, based on the information for locations and attributes of detected road features, and an updating unit 52 that updates the map data. Each of the units of the processor 44 are functional modules driven by a computer program operating on the processor 44, for example. Alternatively, each of the units of the processor 44 may be specialized computing circuits in the processor 44.

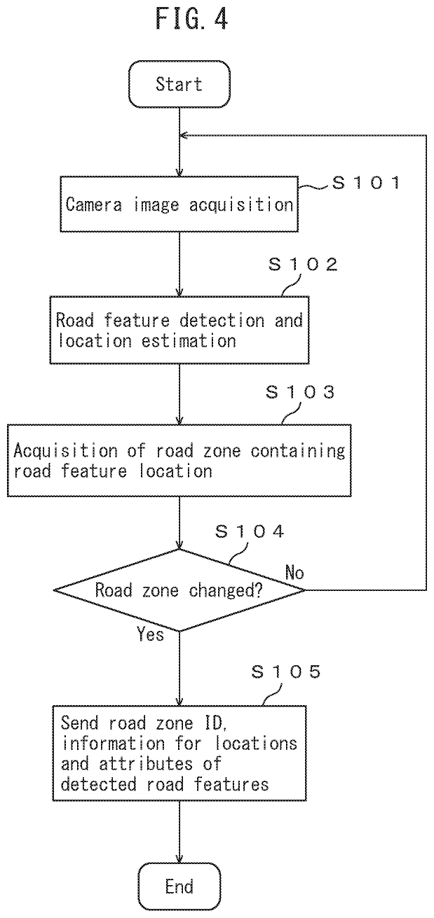

FIG. 4 is an operation flow chart for a vehicle during map data collection processing. In the map data collecting system 1, the data acquiring device 15 of the vehicle 2 repeatedly executes map data acquisition processing according to the operation flow chart shown in FIG. 4 while the vehicle 2 is traveling.

While the vehicle 2 is traveling, a camera 11, as an example of a sensor installed in the vehicle 2, acquires a camera image C in which the surrounding environment of the vehicle 2 is represented (step S101). Each time a camera image C is produced, the camera 11 outputs the camera image C and the camera image acquisition time during which the camera image C was acquired, through the in-vehicle network 16 to the map data acquiring device 15. The camera image C may be used for processing to estimate the current location of the vehicle 2, and for processing to detect any other objects around the vehicle 2.

The data acquiring device 15 of the vehicle 2 detects road features represented in the camera image C and estimates the location of the road features (step S102). The detector 31 of the processor 23 in the data acquiring device 15 detects road features represented in the camera image C input from the camera 11, and detects attribute information of the road features detected in the camera image C while estimating the locations of the road features.

For example, the detector 31 inputs the camera image C into a classifier to detect road features represented in the input camera image C. As the classifier, the detector 31 may use a deep neural network (DNN), for example, that has been trained to detect road features represented in the camera image C, from the input camera image C. For the DNN, the detector 31 may use a DNN having convolutional neural network-type architecture, such as a Single Shot MultiBox Detector (SSD) or Faster R-CNN, for example. In this case, the detector 31 inputs the camera image C into the classifier, and for each type of road feature to be detected (for example, lane marking line, crosswalk or stop line) in different regions of the input camera image C, the classifier calculates the confidence factor representing the likelihood that the road feature is represented in that region, and if a region has a confidence factor for a type of road feature that is above a predetermined detection threshold, it assesses that the road feature of that type is represented. The classifier also outputs information representing regions containing road features that have been detected in the input camera image C (such as detected rectangles outlining road features, hereunder referred to as an “object regions”), and attribute information representing the types of road features represented in the object regions.

Alternatively, the detector 31 may use a classifier other than a DNN. For example, the classifier used by the detector 31 may be a support vector machine (SVM) that has been trained to output a confidence factor for representation of road features to be detected in the window, with the input being a feature descriptor (such as Histogram of Oriented Gradients, HOG, for example) calculated from a window set in the image. The detector 31 varies the location, size and aspect ratio of the window set on the camera image C, while calculating the feature descriptors from the window, and inputting the calculated feature descriptors into the SVM to determine the confidence factor for the window. When the confidence factor is above a predetermined detection threshold, the detector 31 treats the window as an object region in which a detected road feature is represented.

The detector 31 estimates the location of the outside feature represented in the object region, based on the direction from the camera 11 which corresponds to the center of gravity of the object region detected from the camera image C, the location of the vehicle 2, the traveling direction, and internal parameters such as the photographing direction and viewing angle of the camera 11. The detector 31 also notifies the data generating unit 32 of the attribute information and estimated location of the road feature that is detected (detected road feature). The number of road features detected from a single camera C may be zero, or it may be one or more. The detector 31 notifies the data generating unit 32 of this information each time information for locations and attributes of detected road features is detected.

When the data generating unit 32 of the processor 23 in the data acquiring device 15 is notified by the detector 31 of information for the location and attributes of a detected road feature, it acquires the road zone ID representing the road zone in which the detected road feature is located, based on the location of the detected road feature and the traveling route (step S103). The traveling route is generated as a linkage of the road zones on which the vehicle 2 will travel from the current location of the vehicle 2 to the destination. Each road zone is identified by road zone identification information representing the road zone (road zone ID). The data generating unit 32 selects the road zone nearest to the detected road feature among multiple road zones forming the traveling route, as the road zone in which the road feature is located.

The data generating unit 32 assesses whether or not the road zone in which the detected road feature is located has changed (step S104). The data generating unit 32 monitors successively acquired road zone IDs, and when a different road zone ID (second road zone ID) different from the previously acquired road zone ID (first road zone ID) has been selected twice in a row, it assesses that the road zone in which the detected road feature is located has changed.

When the road zone in which the detected road feature is located has changed (step S104—Yes), the data generating unit 32 sends the server 3 information for the detected road feature located in the one road zone (first road zone ID) (step S105). The data generating unit 32 outputs the road zone ID representing the road zone in which the detected road feature is located, and the information for locations and attributes of one or more detected road features, to the wireless communication terminal 12 through the communication interface 21, thus sending the road zone ID and the information for locations and attributes of detected road features to the server 3 via the wireless base station 5 and communication network 4.

When the road zone in which the detected road feature is located has not changed (step S104—No), the procedure returns to step S101. The manner in which the data generating unit 32 sends the server 3 the road zone ID and the information for the locations and attributes of detected road features is not limited to the one described above. For example, the data generating unit 32 may send the server 3 information for locations and attributes of detected road features each time it is notified of the information from the detector 31. The data generating unit 32 may also send the server 3 information for detected road features at predetermined intervals.

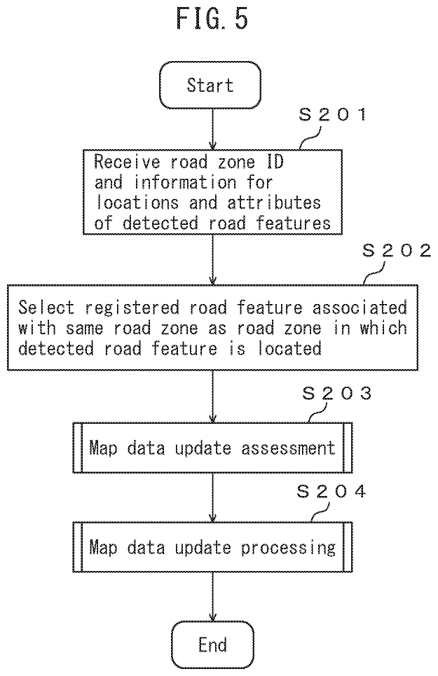

FIG. 5 is an operation flow chart for a server 3 during map data collection processing. The communication interface 41 of the server 3 receives road zone ID and information for locations and attributes of detected road features from the vehicle 2, for one or more detected road features that have been detected in the same single road zone (step S201). The communication interface 41 forwards to the processor 44 the road zone ID and information for locations and attributes of detected road features that have been received from the vehicle 2 via the base station 5 and communication network 4.

The assessment unit 51 of the processor 44 selects a registered road feature associated with the same road zone as the road zone in which the detected road feature is located (step S202). The assessment unit 51 refers to the map data 421 stored in the storage device 42, selects the registered road feature associated with the road zone that matches the road zone ID representing the road zone in which the detected road feature is located, and reads out the information for the location and attributes of the selected registered road feature.

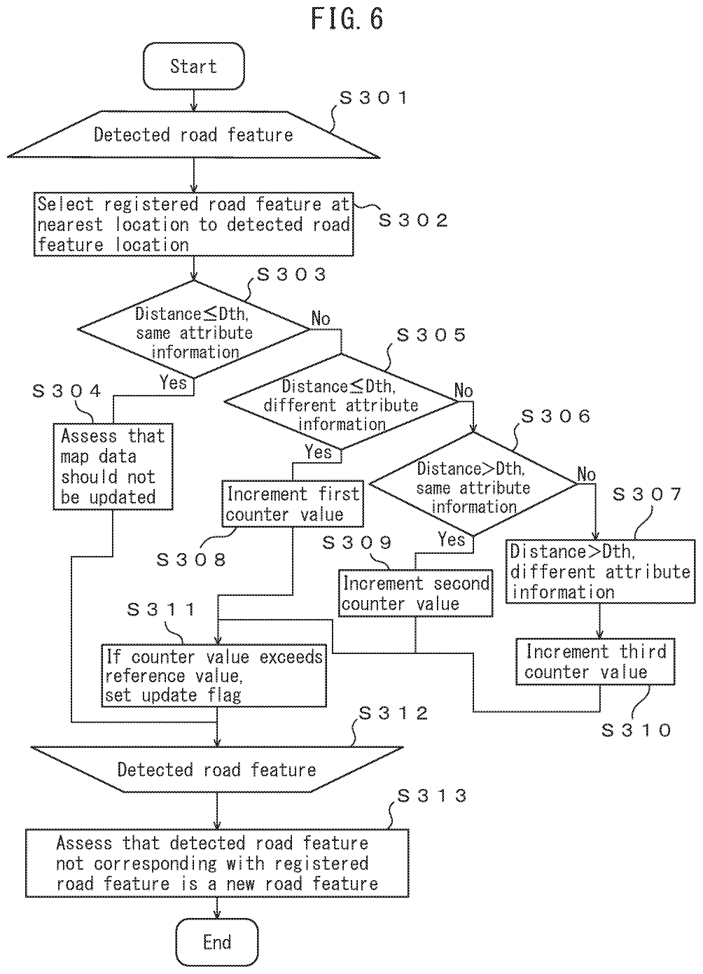

For each detected road feature, the assessment unit 51 of the processor 44 assesses whether the map data 421 should be updated for the detected road feature, based on the attribute information for the detected road feature, the attribute information for the selected registered road feature, and the distance between the detected road feature and the selected registered road feature (step S203). The details regarding assessment processing by the assessment unit 51 will be described below with reference to FIG. 6.

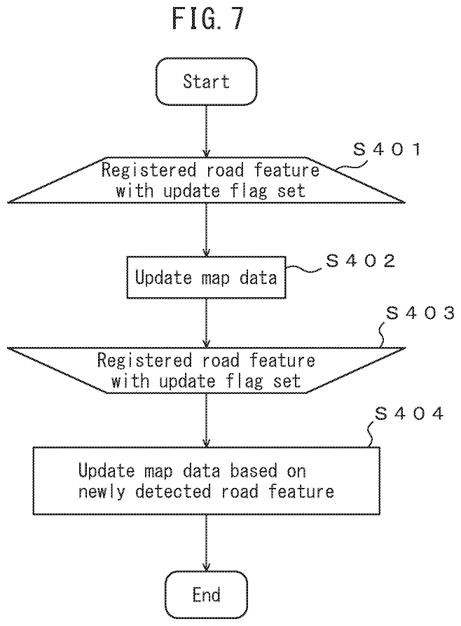

When it has been assessed that an update should be made for a detected road feature, the updating unit 52 of the processor 44 updates the map data 421 stored in the storage device 42 based on the information for the location and attributes of the registered road feature (step S204). The details regarding update processing by the updating unit 52 will be described below with reference to FIG. 7.

FIG. 6 is an operation flow chart for the assessment unit 51 in a processor 44 of a server 3. Assessment processing by the assessment unit 51 in step S203 will now be explained with reference to the operation flow chart of FIG. 6.

The assessment unit 51 executes the loop processing from step S302 to step S311 (step S301 to step S312), for each of one or more detected road features.

Referring to the map data 421, the assessment unit 51 selects the registered road feature at the location nearest to the location of the detected road feature, from among the registered road features associated with the road zone in which the detected road feature is located (step S302). As mentioned above, the location of the detected road feature corresponds to the location of the center of gravity of the object region, and therefore the distance between the location of the detected road feature and the location of the registered road feature is a three-dimensional distance. The assessment unit 51 calculates the distance between each of the one or more registered road features selected in step S302 and the detected road feature, and selects the registered road feature having the shortest distance, as the registered road feature which is the object of comparison with the detected road feature in the loop processing. The selected registered road feature, once selected, is excluded as an object of comparison in subsequent loop processing.

The assessment unit 51 assesses whether the distance between the selected registered road feature and the detected road feature is below a prescribed distance threshold Dth and the attribute information of the selected registered road feature is the same as the attribute information of the detected road feature (step S303). The distance threshold Dth can be determined based on the location precision of the sensor with which the detected road feature was detected. For example, for this embodiment the location of the detected road feature is estimated based on the camera image C acquired from the camera 11 as an example of a sensor, and the threshold Dth is determined based on the location precision in this detection method. Specifically, the location precision in this detection method is determined based on the positional precision of the vehicle 2, the resolving power of the camera image C, and the mounting precision of the camera 11 on the vehicle 2.

When the distance between the selected registered road feature and the detected road feature is below the prescribed distance threshold Dth and the attribute information of the selected registered road feature is the same as the attribute information of the detected road feature (step S303—Yes), the assessment unit 51 assesses that the map data should not be updated (step S304). This is because it estimates that the selected registered road feature and detected road feature are the same.

When, on the other hand, it is denied that the distance between the selected registered road feature and the detected road feature is below the distance threshold Dth and the attribute information of the selected registered road feature is the same as the attribute information of the detected road feature (step S303—No), the assessment unit 51 assesses whether or not the distance between the selected registered road feature and the detected road feature is below the distance threshold Dth and the attribute information of the selected registered road feature differs from the attribute information of the detected road feature (step S305).

When the distance between the selected registered road feature and the detected road feature is below the prescribed distance threshold Dth and the attribute information of the selected registered road feature differs from the attribute information of the detected road feature (step S305—Yes), the assessment unit 51 increments a first counter value for the selected registered road feature (step S308). When the first counter value is incremented for the first time, the first counter value is 1 after step S308. When the first counter value is N for the selected registered road feature, the first counter value after step S308 is N+1. For a registered road feature that has had the first counter value incremented, the assessment unit 51 stores this in the memory 43 or storage device 42 associated with the information for the location and attributes of the detected road feature.

When, on the other hand, it is denied that the distance between the selected registered road feature and the detected road feature is below the distance threshold Dth and the attribute information of the selected registered road feature is different from the attribute information of the detected road feature (step S305—No), the assessment unit 51 assesses whether or not the distance between the selected registered road feature and the detected road feature is greater than the distance threshold Dth and the attribute information of the selected registered road feature differs from the attribute information of the detected road feature (step S306).

When the distance between the selected registered road feature and the detected road feature is greater than the prescribed distance threshold Dth and the attribute information of the selected registered road feature is the same as the attribute information of the detected road feature (step S306—Yes), the assessment unit 51 increments a second counter value for the selected registered road feature (step S309). For a registered road feature that has had the second counter value incremented, the assessment unit 51 stores this in the memory 43 or storage device 42 associated with the information for the location and attributes of the detected road feature.

When, on the other hand, it is denied that the distance between the selected registered road feature and the detected road feature is greater than the distance threshold Dth, and the attribute information of the selected registered road feature is the same as the attribute information of the detected road feature (step S306—No), the assessment unit 51 assesses that the distance between the selected registered road feature and the detected road feature is greater than the distance threshold Dth and that the attribute information of the selected registered road feature differs from the attribute information of the detected road feature (step S307). The assessment unit 51 increments a third counter value for the selected registered road feature (step S310). For a registered road feature that has had the third counter value incremented, the assessment unit 51 stores this in the memory 43 or storage device 42 associated with the information for the location and attributes of the detected road feature.

When the counter value for a registered road feature that has had any of the first counter value to third counter value incremented is greater than a reference value, the assessment unit 51 sets an update flag for that registered road feature (step S311). Specifically, the assessment unit 51 sets a first update flag for a registered road feature whose first counter value has exceeded a reference value, sets a second update flag for a registered road feature whose second counter value has exceeded a reference value, and sets a third update flag for a registered road feature whose third counter value has exceeded a reference value. The reference values may be the same or different for the first counter value to third counter value. For this embodiment, the same reference value is used for the first counter value to third counter value. The reference value is preferably set to be about 5 to 10, for example, from the viewpoint of excluding false positive detection of road features. The reference value may also be 1, however.

After executing loop processing from step S302 to step S311 for each of the one or more detected road features, the assessment unit 51 assesses that any detected road feature that did not correspond to a registered road feature in the loop processing is a new road feature that is not registered in the map data 421 (step S313). The assessment unit 51 notifies the updating unit 52 of information for locations and attributes of detected road features assessed to be new road features. If the number of road features detected in a single road zone is larger than the number of registered road features registered in the map data 421, then a detected road feature that did not correspond to a registered road feature is estimated to be a new road feature. This completes explanation of assessment processing by the assessment unit 51 in step S203.

FIG. 7 is an operation flow chart for the updating unit 52 in a processor 44 of a server 3. Update processing by the updating unit 52 in step S204 will now be explained with reference to the operation flow chart of FIG. 7.

The updating unit 52 carries out update processing with a predetermined update cycle. The updating unit 52 carries out the loop processing of step S402, for each registered road feature having any of the update flags set, from the first update flag to the third update flag set (step S401 to step S403).

The updating unit 52 updates the map data 421 for the registered road feature whose update flag has been set (step S402). The updating unit 52 updates the information for the location and attributes of the registered road feature whose update flags have been set, based on the information for locations and attributes of one or more detected road features stored in the memory 43 or storage device 42 associated with the registered road feature.

When the first update flag has been set for the registered road feature, the updating unit 52 determines the location of the registered road feature to be updated, to be the average value for the locations of multiple detected road features associated with the registered road feature. The updating unit 52 also determines that the attribute information of the registered road feature to be updated should be the greatest volume of attribute information from among the attribute information of the multiple detected road features associated with the registered road feature. The updating unit 52 switches the information for the locations and attributes of the registered road features associated with the road zone ID in the map data 421, to the new information for locations and attributes of the road features. When the first update flag has been set, it is estimated that the reason for information update is that the attribute information of a road feature has changed. A specific example may be when a speed limit road sign, as a typical road feature, has changed from 40 km to 50 km.

When the second update flag has been set for the registered road feature, the updating unit 52 calculates the average value and variance for the locations of multiple detected road features associated with the registered road feature. When the variance is smaller than a reference variance (case 1), the updating unit 52 determines the location of the updated registered road feature to be the average value for the locations of multiple detected road features associated with the registered road feature. The updating unit 52 switches the information for the locations of the registered road features associated with the road zone ID in the map data 421, to the new locations for the road features. The new road feature attribute information is the same as before updating. In case (1) where the second update flag is set, it is estimated that the reason for the information update is either that the location of the road feature has been changed, or that the location of the registered road feature in the map data 421 is not correct. When the variance is above a reference variance (case 2), the updating unit 52 uses k-means clustering with 2 clusters, for example, to calculate the center of gravity of two detected road features associated with the registered road feature (first center of gravity and second center of gravity). The updating unit 52 determines the first center of gravity to be the location of the first road feature, and determines the second center of gravity to be the location of the second road feature. The attribute information of the first road feature and the attribute information of the second road feature are the same as before updating. The updating unit 52 deletes the information for locations and attributes of the registered road features in the map data 421, and registers the new first information for locations and attributes of the road features and the new second information for locations and attributes of the road features in the map data 421, in association with the road zone ID. In case (2) where the second update flag is set, it is estimated that the reason for the information update is that a new road feature has been added to the road near a road feature that was already registered in the map data 421.

When the third update flag has been set for the registered road feature, the updating unit 52 determines the location of the updated registered road feature to be the average value for the locations of multiple detected road features associated with the registered road feature. The updating unit 52 also determines that the attribute information of the registered road feature to be updated should be the greatest volume of attribute information from among the attribute information of the multiple detected road features associated with the registered road feature. The updating unit 52 registers the new information for locations and attributes of road features in the map data 421, in association with the road zone ID. In cases where the third update flag has been set, it is estimated that the reason for information update is that a new road feature has been added to the road.

After the loop processing in step S402 has been carried out for the registered road feature whose update flag has been set, the updating unit 52 updates the map data 421 based on the detected road feature that has been assessed to be a new road feature in step S313 as described above (see FIG. 6) (step S404). The updating unit registers the information for the location and attributes of the detected road feature that has been assessed to be a new road feature, as notified by the assessment unit 51, in the map data 421 in association with the road zone ID.

As explained above, the map data collection device is a map data collection device that collects information for locations and attributes of road features contained in map data used for automatic operation control of a vehicle, and the map data collection device inputs information for the location and attributes of a second road feature detected using a sensor installed in the vehicle, and refers to map data containing information for the locations and attributes of one or more first road features, to select one first road feature present at the nearest location to the location of the second road feature, and to assess whether map data should be updated based on the attribute information for the first road feature, the attribute information for the second road feature and the distance between the first road feature and the second road feature. The map data collection device can therefore compare the location of the second road feature with the information for the location and attributes of the first road feature that is at the nearest location, thereby allowing it to use a smaller processing volume to assess whether map data should be updated. Specifically, for each second road feature located in a single road zone input through the input device, the map data collection device selects one first road feature present at the nearest location to the location of the second road feature, from among first road features associated with the road zone in the map data, and assesses whether the map data should be updated based on the attribute information for the selected first road feature, the attribute information for the second road feature and the distance between the selected first road feature and the second road feature. This allows the map data collection device to reduce the processing volume for selection of the one first road feature present at the nearest location to the location of the second road feature.

A modified example of the map data collecting system described above will now be explained. In the map data collecting system according to a first modified example, the processor 44 of the server 3 may have a data acquisition indicator (not shown) that selects a road zone having no associated road features or fewer than a predetermined reference value, and sends the road zone ID representing that road zone, and an indication of data acquisition, to the vehicle 2. The detector 31 of the vehicle 2 thus detects road features only when traveling in road zones in which indication of data acquisition has been received from the server 3. When a camera image C has been input from the camera 11, the detector 31 assesses, based on positioning information input from the navigation device 14 and the traveling route, whether or not the road zone in which the vehicle 2 is traveling matches the road zone in which indication of data acquisition has been received from the server 3. When the road zone in which the vehicle 2 is traveling matches the road zone in which indication of data acquisition has been received from the server 3, the detector 31 carries out detection of the detected road feature in the camera image C.

In the map data collecting system according to a second modified example, the road features may be registered in the map data 421 in association with traffic lanes within the road zone. The road features are associated with traffic lanes in terms of their proximity with the locations of the road features. The traffic lanes are identified by traffic lane identification information (traffic lane ID). The traffic lanes are associated with the road zone that includes the traffic lane. When one road zone has multiple traffic lanes, the multiple traffic lanes are associated with that road zone. Each of the registered road features of the map data 421 is thus associated with the road zone via the traffic lanes.

In the map data collecting system according to a third modified example, when a predetermined period has elapsed after having assessed that an update flag is set for information for the location and attributes of a detected road feature stored in the memory 43 or storage device 42 and associated with a registered road feature which has an update flag set, the assessment unit 51 of the processor 44 of the server 3 deletes it from the memory 43 or storage device 42. Road features are sometimes erroneously detected by a sensor such as a camera 11 of a vehicle 2. Such road features are preferably deleted since they will not be repeatedly detected.

In the map data collecting system according to a fourth modified example, the detector 31 of the processor 23 of the map data acquiring device 15 of the vehicle 2 may detect the heights of road features. The detector 31 may use the angle θ between the slope of the optical axis of the camera 11 and the direction perpendicular to the ground, the distance D between the vehicle 2 and the road feature, and the size of the road surface expansion vector Rc, in the relationship represented by: Road feature height=Rc/tan θ−D/tan θ, to calculate the height of the road feature. The road surface expansion vector is the vector connecting the base of the normal to the ground drawn from the viewpoint of the camera 11, with the point where a line connecting the camera 11 viewpoint with the apex of the road feature crosses with the ground. The data generating unit 32 of the processor 23 of the vehicle 2 sends the height of the road feature to the server 3, together with the road zone ID and information for the location and attributes of the detected road feature. While carrying out assessment in the update processing by comparison of the detected road feature with the registered road feature present at the nearest location to the detected road feature, the assessment unit 51 of the processor 44 of the server 3 may also add assessment of whether or not the height of the detected road feature matches the height of the registered road feature.

According to the present invention, the map data collection device and the storage medium that stores the computer program for map data collection according to the embodiment described above may incorporate appropriate modifications that are still within the gist of the invention. Moreover, the technical scope of the invention is not limited to this embodiment, and includes the invention and its equivalents as laid out in the Claims.

For example, the map data of the embodiment described above was used for automatic operation control of a vehicle, as an example of a moving object, but the map data may also be used for automatic operation control of a moving object other than a vehicle.

Moreover, for the embodiment described above, the server had the function of the map data collection device, but the map data collection device may instead be disposed in the vehicle.

1. A map data collection device that collects information for locations and attributes of road features contained in map data used for automatic operation control of a moving object, wherein the map data collection device comprises:
a storage device that stores map data containing information for the locations and attributes of one or more first road features;
an input device that inputs information for the location and attributes of a second road feature detected using a sensor installed in the moving object; and
a processor configured to refer to the map data stored in the memory device, to select one first road feature present at the nearest location to the location of the second road feature, and to assess whether map data should be updated based on the attribute information for the first road feature, the attribute information for the second road feature and the distance between the first road feature and the second road feature.

2. The map data collection device according to claim 1, wherein the processor is configured to assess that map data should be updated when the distance between the selected first road feature and the second road feature is below a predetermined threshold and the attribute information for the selected first road feature is different from the attribute information for the second road feature.

3. The map data collection device according to claim 2, wherein the processor is configured to assess that map data should be updated when the distance between the selected first road feature and the second road feature is above a predetermined threshold and the attribute information for the selected first road feature is the same as the attribute information for the second road feature.

4. The map data collection device according to claim 2, wherein the processor is configured to assess that map data should be updated when the distance between the selected first road feature and the second road feature is above a predetermined threshold and the attribute information for the selected first road feature is different from the attribute information for the second road feature.

5. The map data collection device according to claim 2, wherein the processor is configured to assess that map data should not be updated when the distance between the selected first road feature and the second road feature is below a predetermined threshold and the attribute information for the selected first road feature is the same as the attribute information for the second road feature.

6. The map data collection device according to claim 1, wherein the processor is configured to update the map data stored in the memory device based on the information for the location and attributes of the second road feature when it has been assessed that an update should be made.

7. The map data collection device according to claim 6, wherein the processor is configured to count the number of assessments that the map data should be updated for the selected first road feature each time the processor assesses that map data should be updated, and
the processor is configured to update the map data based on the information for the locations and attributes of a predetermined number of second road features used for assessment of the one first road feature, when the number of assessments that the map data should be updated has reached the predetermined number for the selected first road feature.

8. The map data collection device according to claim 1, wherein the memory device stores map data containing information for the locations and attributes of one or more first road features associated with each of a plurality of road zones, and
the processor is configured to select, for each second road feature located in a single road zone that has been input through the input device, one first road feature present at the nearest location to the location of the second road feature from among the first road features associated with the road zone in the map data, to assess whether map data should be updated based on the attribute information for the selected first road feature, the attribute information for the second road feature and the distance between the selected first road feature and the second road feature, and to assess that second road features that were not assessed are new road features.

9. A computer-readable non-transitory storage medium that stores a computer program for map data collection, which collects information for locations and attributes of road features contained in map data used for automatic operation control of a moving object, and
wherein the computer program causes a processor to:
input information for the location and attributes of a second road feature detected using a sensor installed in the moving object via an input device; and
refer to map data that is stored in a memory device and contains information for the locations and attributes of one or more first road features, select one first road feature present at the nearest location to the location of the second road feature, and assess whether map data should be updated based on the attribute information for the first road feature, the attribute information for the second road feature and the distance between the first road feature and the second road feature.
